(19) United States
(12) Patent Application Publication
(10) Pub. No.: US 2026/0039212 A1
(43) Pub. Date: Feb. 5, 2026

(54) HIGH-SIDE DEVICE CONTROL IN PHASE SHIFT FULL BRIDGE DC/DC CONVERTER

(71) Applicant: Renesas Electronics Corporation, Tokyo (JP)

(72) Inventor: Daisuke KOBAYASHI, Tokyo (JP)

(73) Assignee: Renesas Electronics Corporation, Tokyo (JP)

(21) Appl. No.: 18/793,068

(22) Filed: Aug. 2, 2024

(51) Int. Cl. H02M 3/335; H02M 1/08; H02M 1/088; H02M 1/32

(52) U.S. Cl. CPC H02M 3/33573; H02M 1/083; H02M 1/088; H02M 1/32; H02M 3/33592

(57) ABSTRACT

Gate drivers, systems and methods are described. A gate driver can include a comparator configured to detect a zero voltage switching (ZVS) event of a high-side (HS) switching device and in response to detection of the ZVS event, generate an ON signal to turn on the HS switching device. The gate driver can further include a timing circuit configured to an OFF signal to turn off the HS switching device, wherein generation of the OFF signal is based on a predefined fixed ON time of the HS switching device.

### BACKGROUND OF THE SPECIFICATION

The present disclosure relates in general to semiconductor devices. More specifically, the present disclosure relates to an architecture of a control scheme for high side device control in phase shift full bridge DC/DC converters.

Gate drivers are used in switching converter applications such as DC/DC converters, inverters, motor drivers, etc. These system can include a controller, one or more power switches and gate drivers for each switches. The gate drivers drive its power switch to on state and off state according to the controller's signal and the system provides required output voltage or power to the load. A phase shifted full bridge (PSFB) DC/DC converter is used for DC-DC conversion in various applications, such as automotive (e.g., HEV-Hybrid Electric Vehicles, EV-Electric Vehicles), digital power systems (e.g., Industrial Power and Battery Back-Up Systems), power supplies, telecom rectifiers, battery charging systems, and renewable energy systems. PSFB DC/DC converters can be used for stepping down high DC bus voltages and/or provide isolation in medium to high power applications. A PSFB DC/DC converter includes four power electronic switching devices, such as metal-oxide-semiconductor field-effect transistors (MOSFETs) or insulated-gate bipolar transistors (IGBTs), that form a full bridge on the primary side of an isolation transformer. The PSFB DC/DC converter can further include diode rectifiers or MOSFET switches for synchronous rectification (SR) on the secondary side of the isolation transformer. This topology allows all four power electronic switching devices to switch with zero voltage switching (ZVS) resulting in lower switching losses and an efficient converter.

### SUMMARY

In one embodiment, a semiconductor device is generally described. The semiconductor device can include a comparator configured to detect a zero voltage switching (ZVS) event of a high-side (HS) switching device. The comparator can be further configured to, in response to detection of the ZVS event, generate an ON signal to turn on the HS switching device. The semiconductor device can further include a timing circuit configured to an OFF signal to turn off the HS switching device, wherein generation of the OFF signal is based on a predefined fixed ON time of the HS switching device.

In one embodiment, a system implementing a voltage converter is generally described. The system can include a first half bridge including a first high-side (HS) switching device and a first low-side (HS) switching device. The system can further include a second half bridge including a second high-side (HS) switching device and a second low-side (HS) switching device. The system can further include a first LS gate driver configured to control an ON time of the first LS switching device. The system can further include a second LS gate driver configured to control an ON time of the second LS switching device. The system can further include a controller configured to control an OFF time of the first LS switching device and the OFF time of the second LS switching device. The system can further include a first HS gate driver configured to control an ON time and an OFF time of the first HS switching device. The system can further include a second HS gate driver configured to control an ON time and an OFF time of the second HS switching device.

In one embodiment, a method for operating a voltage converter is generally described. The method can include detecting a zero voltage switching (ZVS) event of a high-side (HS) switching device. The method can further include, in response to detecting the ZVS event, generating an ON signal to turn on the HS switching device. The method can further include generating an OFF signal to turn off the HS switching device, wherein generation of the OFF signal is based on a predefined fixed ON time of the HS switching device.

The foregoing summary is illustrative only and is not intended to be in any way limiting. In addition to the illustrative aspects, embodiments, and features described above, further aspects, embodiments, and features will become apparent by reference to the drawings and the following detailed description. In the drawings, like reference numbers indicate identical or functionally similar elements.

### BRIEF DESCRIPTION OF THE DRAWINGS

FIG. 1 is a diagram showing a system that can implement high side device control in phase shift full bridge DC/DC converter in one embodiment.

FIG. 2A is a diagram showing an example implementation of high side device control in phase shift full bridge DC/DC converter in one embodiment.

FIG. 2B is a diagram showing another example implementation of high side device control in phase shift full bridge DC/DC converter in one embodiment.

FIG. 3 is a diagram showing timing diagrams of an example implementation of high side device control in phase shift full bridge DC/DC converter in one embodiment.

FIG. 4A is a diagram showing an example implementation of a comparator in high side device control in phase shift full bridge DC/DC converter in one embodiment.

FIG. 4B is a diagram showing another example implementation of a comparator in high side device control in phase shift full bridge DC/DC converter in one embodiment.

FIG. 5A is a diagram showing another example implementation of a comparator in high side device control in phase shift full bridge DC/DC converter in one embodiment.

FIG. 5B is a diagram showing another example implementation of a comparator in high side device control in phase shift full bridge DC/DC converter in one embodiment.

FIG. 6 is a diagram showing an example implementation of a timer and a logic circuit in high side device control in phase shift full bridge DC/DC converter in one embodiment.

FIG. 7 illustrates a flow diagram of a process to implement high side device control in phase shift full bridge DC/DC converter in one embodiment.

### DETAILED DESCRIPTION

In the following description, numerous specific details are set forth, such as particular structures, components, materials, dimensions, processing steps and techniques, to provide an understanding of the various embodiments of the present application. However, it will be appreciated by one of ordinary skill in the art that the various embodiments of the present application may be practiced without these specific details. In other instances, well-known structures or processing steps have not been described in detail to avoid obscuring the present application.

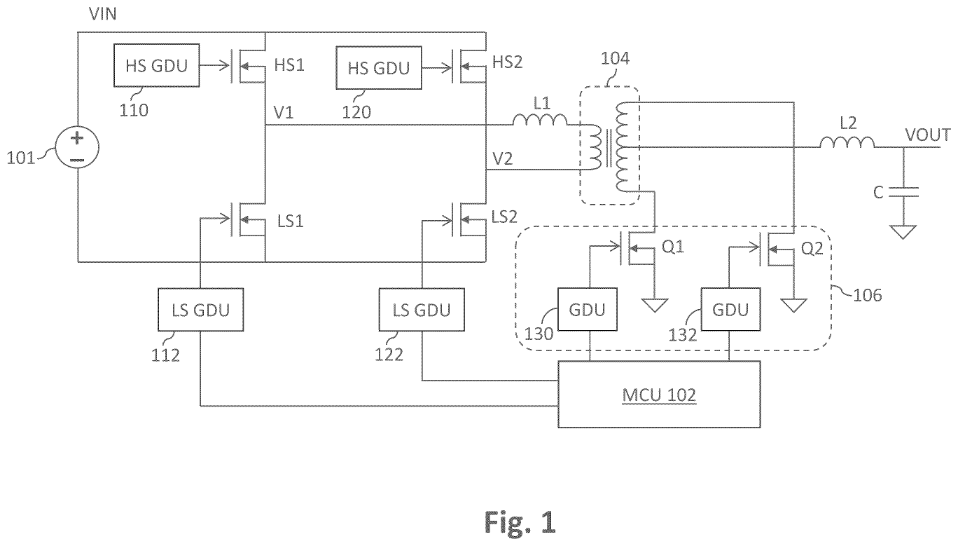

FIG. 1 is a diagram showing a system that can implement high side device control in phase shift full bridge DC/DC converter in one embodiment. System 100 can implement a phase shift full bridge (PSFB) DC/DC converter that converts an input voltage VIN into output voltage VOUT. System 100 can step down input voltage VIN such that VOUT can have a lower voltage level than VIN. System 100 can include at least a power source 101, a microcontroller (MCU) 102, an isolation transformer 104, a synchronous rectification circuit 106, gate drivers 110, 112, 120, 122, and four power electronic switching devices labeled as HS1, HS2, LS1, LS2. Gate drivers 110, 112, 120, 122 are labeled as HS GDU (high-side gate driver unit) and LS GDU (low-side gate driver unit) in FIG. 1. Power source 101 can be configured to provide VIN to system 100. Devices HS1, HS2 can be high-side devices connected between VIN and their corresponding output switch nodes. Devices LS1, LS2 can be low-side devices connected between their corresponding output switch nodes and ground.

Devices HS1, HS2, LS1, LS2 can be, for example, metal-oxide-semiconductor field-effect transistors (MOSFETs) or insulated-gate bipolar transistors (IGBTs). Gate drivers 110, 112, 120, 122 can be configured to drive the gates of devices HS1, LS1, HS2, LS2, respectively. Devices HS1, HS2, LS1, LS2 can form a full bridge on the primary side of isolation transformer 104. Devices HS1, LS1 can form a first leg (or left leg) of the full bridge and devices HS2, LS2 can form a second leg (or right leg) of the full bridge. A phase shift is present between voltage V1 outputted by the first leg and voltage V2 outputted by the second leg. Power can be provided from the primary side of the transformer 104 to the secondary side of the transformer 104 during the overlapping periods between V1 and V2. Devices HS1, HS2, LS1, LS2 can be switched with zero voltage switching (ZVS), which can lead to relatively lower switching losses and higher efficiency. In an aspect, the duty cycle of each leg can be fixed at (or approximately) 50%, zero voltage switching (ZVS) operation can be implemented with help from an inductor L1 on the primary side of transformer 104.

Synchronous rectification circuit 106 can be positioned on the secondary side of isolation transformer 104. Synchronous rectification circuit 106 can include switching devices Q1, Q2 and gate drivers 130, 132 for driving the gates of switching devices Q1, Q2. Devices Q1, Q2 can be MOSFETs.

MCU 102 can include, for example, a processor, central processing unit (CPU), field-programmable gate array (FPGA) or any other circuitry that is configured to control and operate gate drivers 112, 122, 130, 132. While described as a CPU in illustrative embodiments, MCU 102 is not limited to a CPU in these embodiments and may comprise any other circuitry that is configured to control and operate gate drivers 112, 122, 130, 132.

In an aspect, a gate driver being controlled by MCU requires an isolator, such as opto-coupler, capacitive coupler or inductive coupler, to protect the gate driver from various events such as unwanted transients and DC voltages for high-voltage systems. However, isolators must have high voltage tolerance therefore their physical size can be relatively large, thus occupying mode board space and cost relatively more. In an aspect, conventional PSFB DC/DC converters can use MCU to control all gate drivers, including both the high-side and low-side gate drivers, and the MCU is also tasked with controlling dead-time between high-side and low-side devices. Optimum dead-time can lead to improved efficiency.

To be described in more detail below, the high-side gate drivers 110, 120 in system 100 is not being controlled by MCU 102. By way of example, high-side gate drivers 110, 120 are disconnected from MCU 102 as shown in FIG. 1. As a result of not being controlled by MCU 102, the high-side gate drivers 110, 120 do not include isolators, hence reducing size and cost of PSFB DC/DC converter being implemented by system 100. Further, the high-side gate drivers 110, 120 can include circuitry configured to control dead-time despite not being controlled by MCU 102.

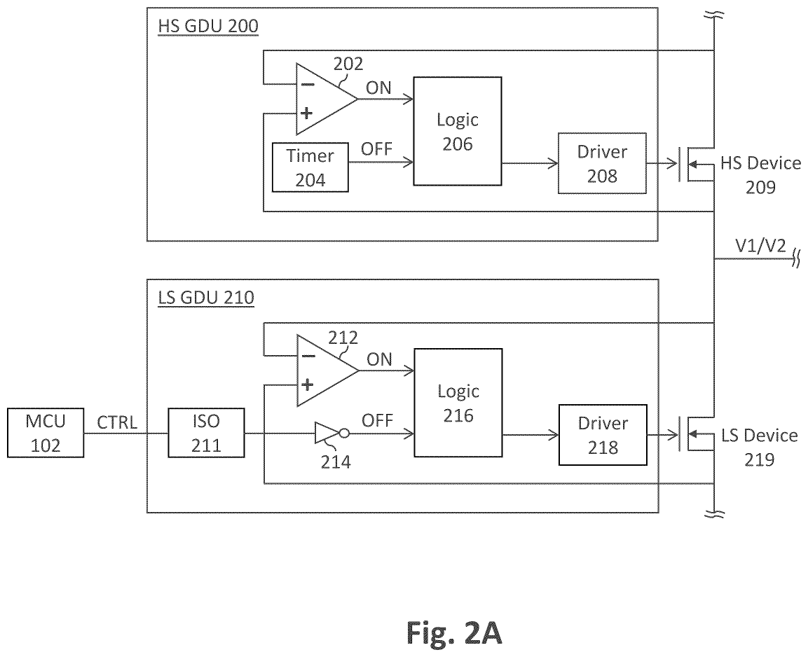

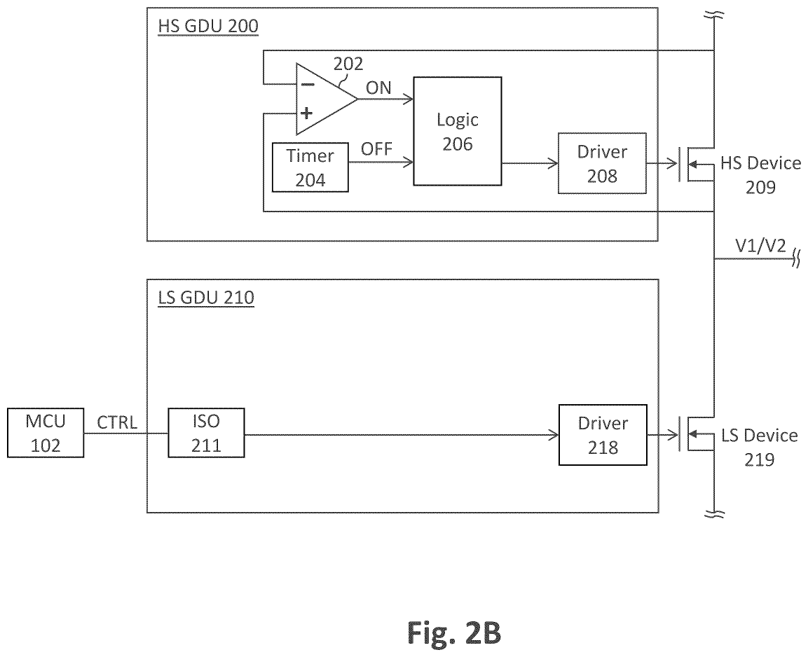

FIG. 2A is a diagram showing an example implementation of high side device control in phase shift full bridge DC/DC converter in one embodiment. Description of FIG. 2A can reference components shown in FIG. 1. Example implementations of the HS GDUs and LS GDUs (as shown in FIG. 1) are shown in FIG. 2A. HS GDU 200 shown in FIG. 2A can be either gate driver 110 or gate driver 120 and LS GDU 210 shown in FIG. 2A can be either gate driver 112 or gate driver 122. HS GDU 200 can be configured to drive the gate of a HS device 209 and LS GDU 200 can be configured to drive the gate of a LS device 209. HS device 209 can be either HS1 or HS2 shown in FIG. 1 and LS device 219 can be either LS1 or LS2 shown in FIG. 1.

HS GDU 200 can include a comparator 202, a timer 204, a logic circuit 206 (“logic 206”) and a driver 208. Comparator 202 can measure the drain-source voltage VDS across HS device 209. The inverting input (−) of comparator 202 can receive voltage between VIN and the drain of HS device 209. The non-inverting input (+) of comparator 202 can receive voltage between the source of HS device 209 and the switch node outputting either V1 or V2. When a ZVS event occurs at HS device 209, such as when VDS of HS device 209 is less than or equal to zero, comparator 202 can output an ON signal (e.g., logic high, or high voltage) to logic circuit 206. Otherwise, comparator 202 can output a logic low or zero volts.

Timer 204 can be a timing circuit configured to determine a lapse of the fixed ON time and output the OFF signal every time the fixed ON time lapsed in order to trigger logic circuit 206 to force a turn off of HS device 209. In an aspect, the half-bridge formed by HS device 209 and LS device 219 has a fixed duty cycle of 50% in PSFB converter. Hence, the ON time for HS device 209 is also fixed.

Logic circuit 206 can receive the ON signal from comparator 202 and receive the OFF signal from timer 204. Logic 206 can be configured to turn on driver 208, turn off driver 208 or maintain driver 208 in on or off states, depending on the values of the ON and OFF signals being received. By way of example, when the ON signal from comparator 202 is high and the OFF signal from timer 204 is low, logic circuit 206 can turn on driver 208 to turn on HS device 209. When the ON signal from comparator 202 is low and the OFF signal from timer 204 is high, logic circuit 206 can turn off driver 208 to turn on HS device 209. When both the ON signal from comparator 202 and the OFF signal from timer 204 are low, logic circuit 206 can maintain an ON state of driver 208 to keep HS device 209 ON.

LS GDU 210 can include an isolator 211, a comparator 212, an inverter 214, a logic circuit 216 (“logic 216”) and a driver 218. Comparator 212 can be identical to comparator 202 an logic circuit 216 can be identical to logic circuit 206. Comparator 212 can measure the drain-source voltage VDS across LS device 219. The inverting input (−) of comparator 212 can receive voltage between the switch node outputting either V1 or V2 and the drain of LS device 219. The non-inverting input (+) of comparator 212 can receive voltage between the source of LS device 219 and ground. When a ZVS event occurs at LS device 219, such as when VDS of LS device 219 is less than or equal to zero, comparator 212 can output an ON signal (e.g., logic high, or high voltage) to logic circuit 216. Otherwise, comparator 202 can output a logic low or zero volts.

MCU 102 can control switching frequency and phase shift of the half bridge shown in FIG. 2A by generating and sending a control signal CTRL to LS GDU 210. Isolator 211 can be, for example, an opto-coupler, a capacitive coupler or an inductive coupler, configured to protect LS GDU 210 from unwanted transients resulting from the transmission of the control signal CTRL. By way of example, the CTRL can be provided to logic circuit 216, via isolator 211 and inverter 214, as an OFF signal. Thus, MCU 102 can control the ON and OFF times of LS device 219 by sending CTRL signal to force LS device 219 to turn off.

Logic circuit 216 can receive the ON signal from comparator 212 and receive the OFF signal from inverter 214. Logic 216 can be configured to turn on driver 218, turn off driver 218 or maintain driver 218 in on or off states, depending on the values of the ON and OFF signals being received. By way of example, when the ON signal from comparator 212 is high and the OFF signal from inverter 214 is low, logic circuit 216 can turn on driver 218 to turn on LS device 219. When the ON signal from comparator 212 is low and the OFF signal from inverter 214 is high, logic circuit 216 can turn off driver 218 to turn on LS device 219. When both the ON signal from comparator 212 and the OFF signal from inverter 214 are low, logic circuit 216 can maintain an ON state of driver 218 to keep HS device 219 ON.

In another embodiment shown in FIG. 2B, MCU 102 can control switching frequency and phase shift of the half bridge by generating and sending control signal CTRL to LS GDU 210. The CTRL signal from MCU 102 can turn on or turn off LS device 219 without using comparator 212 shown in FIG. 2A. In one embodiment, the example implementations shown in FIG. 2A or FIG. 2B can be applicable to one of the legs or half bridge shown in FIG. 1, such as the leg including devices HS1 and LS1 or the leg including devices HS2 and LS2. In one embodiment, the example implementations shown in FIG. 2A or FIG. 2B can be applicable to both legs or half bridges shown in FIG. 1 such that both HS1, HS2 will not be controlled by MCU 102. For both embodiments shown in FIG. 2A and FIG. 2B, HS GDU 200 is not being controlled by MCU 102.

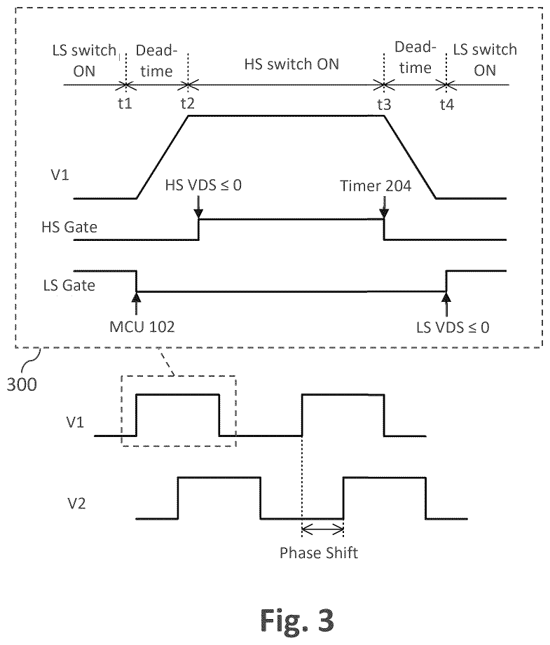

FIG. 3 is a diagram showing timing diagrams of an example implementation of high side device control in phase shift full bridge DC/DC converter in one embodiment. Description of FIG. 3 can reference components shown in FIG. 1 and FIG. 2. As shown by the example timing diagrams in FIG. 3, voltages V1 and V2 are out of phase as a result of a phase shift that can be controlled and performed by MCU. Details of time period 300 are shown in FIG. 3. In time period 300, the voltage, various signal events of the example implementation shown in FIG. 2A, FIG. 2B at times t1, t2, t3, t4 are shown. Prior to time t1, LS device 219 is in an ON state. At time t1, MCU 102 can send CTRL signal to trigger logic circuit 216 to turn off LS device 219, as shown by the LS GATE signal's falling edge at time t1. In response to LS device 219 being turned off, dead-time where both HS device 209 and LS device 219 are turned off can begin. As LS device 219 remains off, a ZVS event can occur at time t2 (e.g., VDS of HS device 209 being less than or equal to zero) and comparator 202 can output the ON signal to logic circuit 206 to trigger logic circuit 206 to turn on driver 208. The ON signal can also switch HS device 209 on, thus ending the dead-time at time t2. In an aspect, PSFB DC/DC converters operate at a fixed 50% duty cycle. Therefore, timer 204 can be programmed with a fixed HS switch ON time and output the OFF signal when the fixed HS switch ON time has lapsed.

The HS switch ON time can start from time t2 and end at time t3. Thus, at time t3, timer 204 will generate the OFF signal to trigger logic circuit 206 to turn off driver 208, which turns off HS device 209 as well. In response to HS device 209 being turned off, the dead-time can begin at time t3. As HS device 209 remains off, a ZVS event can occur at time t4 (e.g., VDS of LS device 219 being less than or equal to zero) and comparator 212 can output the ON signal to logic circuit 216 to trigger logic circuit 216 to turn on driver 218. The ON signal can also switch LS device 219 on, thus ending the dead-time at time t4. Comparator 202 can control the OFF to ON transition of HS device 209 and timer 204 can control the ON to OFF transition of HS device 209. Also, comparator 212 can control the OFF to ON transition of LS device 219 and MCU 102 can control the ON to OFF transition of LS device 219. Since HS device 209 is not being controlled by MCU 102, isolator is not required in HS GDU 110, 120 or 200. Also, the optimum dead-time can be determined in a relatively easy manner when compared to conventional PSFB converters that require the MCU to perform relatively complex computations. MCU 102 can be configured to control the phase shift between V1 and V2 the same as PSFB converter.

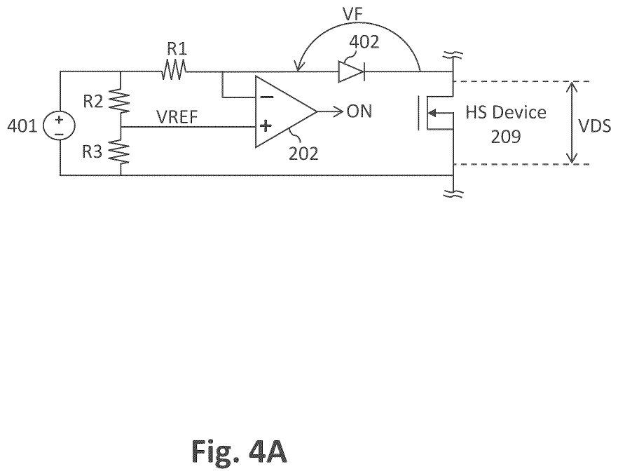

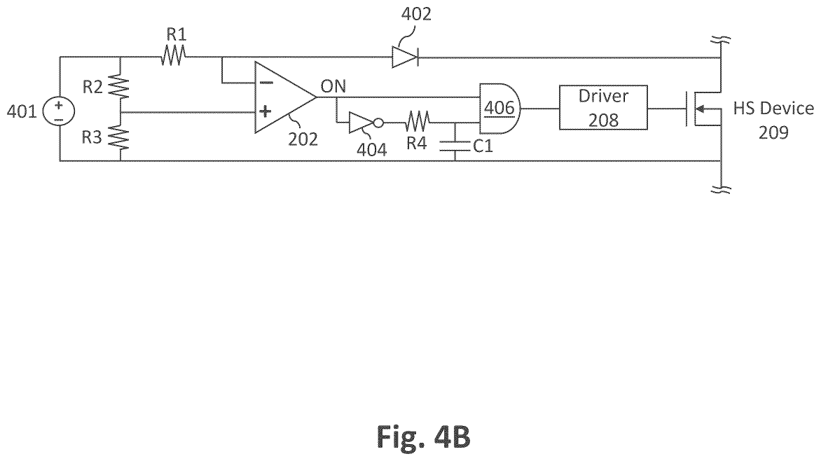

FIG. 4A is a diagram showing an example implementation of a comparator in high side device control in phase shift full bridge DC/DC converter in one embodiment. Description of FIG. 4A can reference components of FIG. 1 to FIG. 3. An example implementation of comparator 202 is shown in FIG. 4A. In the example embodiment shown in FIG. 4A, a voltage source 401 can provide power to components within HS GDU 200 and a diode 402 can be connected to HS GDU 200. Diode 402 can be integrated inside GDU 200, or can be an external diode (e.g., outside of) if GDU 200 cannot handle or process high voltages that depends on the semiconductor technology of HS GDU 200. Before ZVS event, the drain of HS device 209 is high and diode 402 is reverse biased, then resistor R1 pulls up the negative input of comparator 202 above the positive input. At ZVS event, the drain of HS device 209 goes to negative voltage and it pulls down negative or inverting input of comparator 202 via diode 402, then ON signal is asserted. Thus, the embodiment shown in FIG. 4A can implement switching with diode 402 functioning as a protection mechanism to protect comparator 202 against high voltages. In one embodiment, the voltage source 401 can generate a voltage that sets a reference voltage VREF, where VREF can be based on the voltage from the source of HS device 209 and the voltage from voltage source 401 via the resistors R2, R3. The ZVS event can be when the drain-source voltage VDS across HS device 209 is greater than a threshold that can be a different between VREF and VF, where VF feedback voltage from the drain across diode 402. (e.g., VDS<VREF−VF). In one embodiment, VREF can be set to VF such that the ZVS event can be when VDS reaches zero (e.g., VREF-VF=0). In another embodiment, VREF can be set to a value that is higher than VF, such as 1V higher than VF or a relatively small value higher than VF, in order to allow an early toggle to compensate delays caused by comparator 202.

FIG. 4B is a diagram showing another example implementation of a comparator in high side device control in phase shift full bridge DC/DC converter in one embodiment. Description of FIG. 4A can reference components of FIG. 1 to FIG. 4A. In the embodiment shown in FIG. 4B, an additional over current protection circuit with components that may incur relatively small cost, such as an inverter 404 and an AND gate 406, can be added to the embodiment shown in FIG. 4A to provide over current protection. By way of example, if abnormal high current is flowing into the drain of HS device 209, then the negative input of comparator 202 rises above the positive input of comparator 202 and turns off the HS device 209 for safety. If over current did not happen, logic 206 turns off the HS device 209 after fixed time defined by RC circuit, in this example. Thus, the embodiment shown in FIG. 4B can implement switching and over current protection.

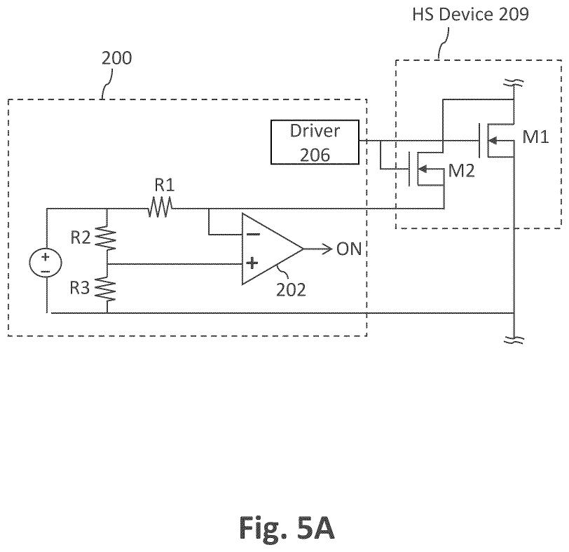

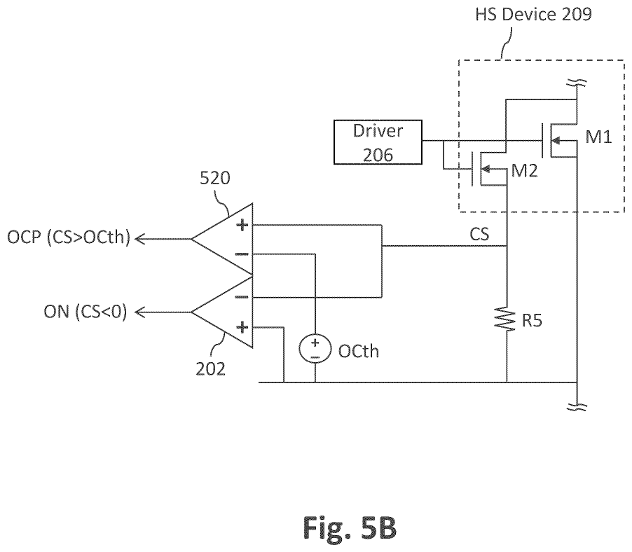

FIG. 5A is a diagram showing another example implementation of a comparator in high side device control in phase shift full bridge DC/DC converter in one embodiment. Description of FIG. 5A can reference components of FIG. 1 to FIG. 4B. An example implementation of comparator 202 is shown in FIG. 5A. In the example embodiment shown in FIG. 5A, HS device 209 can include more than one switching devices, such as more than one field effect transistors (FETs), MOSFETs, such as M1 and M2. In the example embodiment shown in FIG. 5, the device M1 can be switched by driver 208 for driving the voltage V1 or V2 and the device M2 can be used for comparator 202. Body diode of M2 works similarly to diode 402 in FIG. 4A.

FIG. 5B is a diagram showing another example implementation of a comparator in high side device control in phase shift full bridge DC/DC converter in one embodiment. Description of FIG. 5B can reference components of FIG. 1 to FIG. 5A. FIG. 5B is a diagram showing another example of comparator 202 and OCP. At ZVS event, the drain of HS device 209 goes to negative voltage and a current sense (CS) signal is pulled down to negative voltage via body diode of M2. While HS device 209 is ON state, partial current of HS device 209 flows through resistor R5 at CS and current can be monitored by voltage at CS. Over current is detected if CS voltage exceeds an over current threshold (OCth). By way of example, a comparator 520 can compare the CS signal with OCth and output a OCP signal when CS>OCth. Comparator 202 can compare the CS signal with zero (e.g., ground) and output the ON signal when CS<0. Thus, the embodiment shown in FIG. 5B can implement switching, over current protection and current sensing.

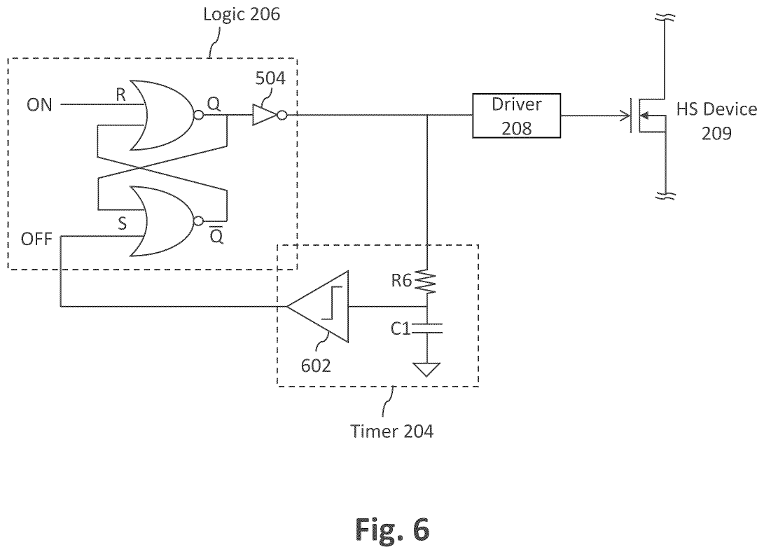

FIG. 6 is a diagram showing an example implementation of a timer and a logic circuit in high side device control in phase shift full bridge DC/DC converter in one embodiment. Description of FIG. 6 can reference components of FIG. 1 to FIG. 5B. Example implementations of timer 204 and logic circuit 206 are shown in FIG. 6. Timer 204 can include a comparator 602 configured to generate OFF signal. By way of example, a ZVS event can trigger the ON signal to high, then logic 206 outputs high. The capacitor CI can be charged at a relatively slow rate via resistor R6. After a certain time, the predefined fixed ON time for the HS device 209, it reaches the threshold voltage of comparator 602 and OFF signal is set high, then logic 206 outputs low. Logic circuit 206 can be implemented by a SR latch and an inverter 504. The ON signal from comparator 202 can be provided to the reset (R) pin of the SR latch and the OFF signal from timer 204 can be provided to the set(S) pin of the SR latch. The Q output of the SR latch can be provided to an inverter 504 and the output of the inverter 504 can be provided to driver 208 to turn driver 208 ON or OFF.

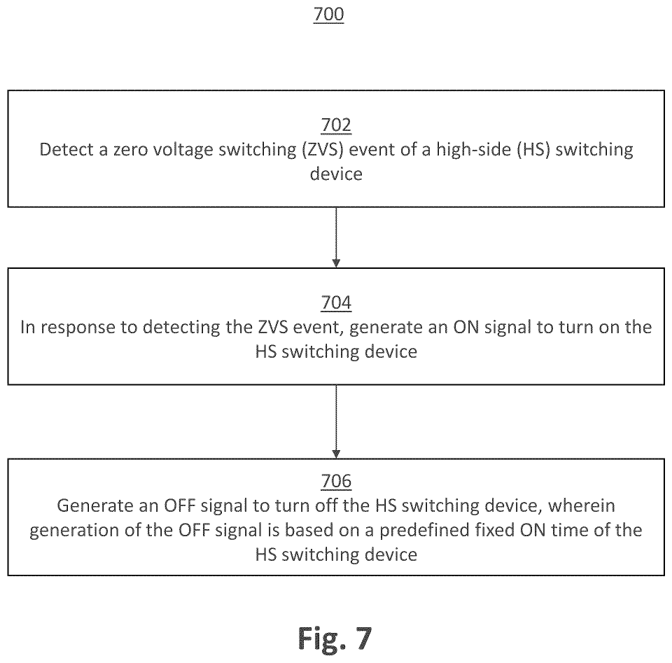

FIG. 7 illustrates a flow diagram of a process to implement high side device control in phase shift full bridge DC/DC converter in one embodiment. Description of FIG. 7 can reference components shown in FIG. 1 to FIG. 6. The process 700 can include one or more operations, actions, or functions as illustrated by one or more of blocks 702, 704 and/or 706. Although illustrated as discrete blocks, various blocks may be divided into additional blocks, combined into fewer blocks, eliminated, performed in different order, or performed in parallel, depending on the desired implementation.

Process 700 can be performed by a gate driver, such as the HS gate drivers 110, 120, 200 described herein. Process 700 can begin at block 702. At block 702, the gate driver can detect a zero voltage switching (ZVS) event of a high-side (HS) switching device. In one embodiment, the HS switching device can be one of two HS switching devices in a phase shift full bridge (PSFB) DC/DC converter. In one embodiment, the gate driver can detect the ZVS event by detecting a drain-source voltage of the HS switching device is less than or equal to zero.

Process 700 can proceed from block 702 to block 704. At block 704, the gate driver can, in response to detecting the ZVS event, generate an ON signal to turn on the HS switching device. Process 700 can proceed from block 704 to block 706. At block 706, the gate driver can generate an OFF signal to turn off the HS switching device, wherein generation of the OFF signal is based on a predefined fixed ON time of the HS switching device. In one embodiment, detecting the drain-source voltage of the HS switching device is less than or equal to zero can include comparing voltages at a drain terminal and a source terminal of the HS switching device. In one embodiment, the gate driver can determine a lapse of the predefined fixed ON time of the HS switching device and generate the OFF signal to turn off the HS switching device in response to determining the lapse.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The disclosed embodiments of the present invention have been presented for purposes of illustration and description but are not intended to be exhaustive or limited to the invention in the forms disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A semiconductor device comprising:
a comparator configured to:
detect a zero voltage switching (ZVS) event of a high-side (HS) switching device; and
in response to detection of the ZVS event, generate an ON signal to turn on the HS switching device; and
a timing circuit configured to generate an OFF signal to turn off the HS switching device, wherein generation of the OFF signal is based on a predefined fixed ON time of the HS switching device.

2. The semiconductor device of claim 1, wherein the HS switching device is one of two HS switching devices in a phase shift full bridge (PSFB) DC/DC converter.

3. The semiconductor device of claim 1, wherein the ZVS event indicates a drain-source voltage of the HS switching device is less than a difference between a reference voltage being provided to the comparator and a voltage at a drain terminal of the HS switching device.

4. The semiconductor device of claim 1, wherein the comparator and the timing circuit are parts of a gate driver for the HS switching device, and the semiconductor further comprises a diode connected between the HS gate driver and the HS switching device, the diode being configured to protect the HS gate driver from voltages that exceed a blocking voltage of the HS gate driver.

5. The semiconductor device of claim 4, wherein the semiconductor further comprises a over current protection circuit configured to perform over current detection for the HS gate driver.

6. The semiconductor device of claim 1, wherein the comparator and the timing circuit are parts of a gate driver for the HS switching device, and the semiconductor further comprises a transistor connected between the gate driver and a drain of the HS switching device, the transistor being configured to perform current sensing and over current protection for the HS gate driver.

7. A system comprising:
a first half bridge including a first high-side (HS) switching device and a first low-side (HS) switching device;
a second half bridge including a second high-side (HS) switching device and a second low-side (HS) switching device;
a first LS gate driver configured to control an ON time of the first LS switching device;
a second LS gate driver configured to control an ON time of the second LS switching device;
a controller configured to control an OFF time of the first LS switching device and the OFF time of the second LS switching device;
a first HS gate driver configured to control an ON time and an OFF time of the first HS switching device; and
a second HS gate driver configured to control an ON time and an OFF time of the second HS switching device.

8. The system of claim 7, wherein each one of the ON times of the first HS switching device and the second HS switching device is a predefined fixed ON time.

9. The system of claim 8, wherein at least one of the first HS gate driver and the second HS gate driver comprises:
a comparator configured to:
detect a zero voltage switching (ZVS) event of a corresponding HS switching device; and
in response to detection of the ZVS event, generate an ON signal to turn on the corresponding HS switching device; and
a timing circuit configured to generate an OFF signal to turn off the HS switching device, wherein generation of the OFF signal is based on the predefined fixed ON time of the corresponding HS switching device.

10. The system of claim 9, wherein:
the ZVS event indicates a drain-source voltage of the corresponding HS switching device is less than a difference between a reference voltage being provided to the comparator and a voltage at a drain terminal of the corresponding HS switching device.

11. The system of claim 7, wherein the first half bridge and the second half bridge are parts of a phase shift full bridge (PSFB) DC/DC converter.

12. The system of claim 7, further comprising:
a first diode connected between the first HS gate driver and the first HS switching device, the first diode being configured to protect the first HS gate driver from voltages that exceed a blocking voltage of the first HS gate driver; and
a second diode connected between the first LS gate driver and the first LS switching device, the second diode being configured to protect the second HS gate driver from voltages that exceed a blocking voltage of the second HS gate driver.

13. The system of claim 12, wherein:
the first HS gate driver further comprises a first over current protection circuit configured to perform over current detection for the first HS gate driver; and
the second HS gate driver further comprises a second over current protection circuit configured to perform over current detection for the second HS gate driver.

14. The system of claim 7, further comprising:
a first transistor connected between the first HS gate driver and a drain of the first HS switching device, the first transistor being configured to perform current sensing and over current protection for the first HS gate driver; and
a second transistor connected between the second HS gate driver and a drain of the second HS switching device, the second transistor being configured to perform current sensing and over current protection for the second HS gate driver.

15. The system of claim 7, wherein:
at least one of the first LS gate driver and the second LS gate driver comprises a comparator configured to:
detect a zero voltage switching (ZVS) event of a corresponding LS switching device; and
in response to detection of the ZVS event, generate an ON signal to turn on a corresponding HS switching device.

16. A method for operating a voltage converter, the method comprising:
detecting a zero voltage switching (ZVS) event of a high-side (HS) switching device;
in response to detecting the ZVS event, generating an ON signal to turn on the HS switching device; and
generating an OFF signal to turn off the HS switching device, wherein generation of the OFF signal is based on a predefined fixed ON time of the HS switching device.

17. The method of claim 16, wherein the HS switching device is one of two HS switching devices in a phase shift full bridge (PSFB) DC/DC converter.

18. The method of claim 17, wherein detecting the ZVS event comprises detecting a drain-source voltage of the HS switching device is less than a difference between a reference voltage being provided to the comparator and a voltage at a drain terminal of the HS switching device.

19. The method of claim 18, wherein detecting the drain-source voltage of the HS switching device is less than the difference comprises operating a comparator to compare the voltages at the drain terminal of the HS switching device with the reference voltage.

20. The method of claim 18, further comprising:
determining a lapse of the predefined fixed ON time of the HS switching device; and
generating the OFF signal to turn off the HS switching device in response to determining the lapse.
